(19) United States
(12) Patent Application Publication
(10) Pub. No.: US 2002/0032794 A1
(43) Pub. Date: Mar. 14, 2002

(54) Information processing device, method thereof and recording medium

(76) Inventors: Yoshifumi Nishida, Kanagawa (JP); Fumio Teraoka, Tokyo (JP)

Correspondence Address: William S. Frommer, Esq., FROMMER LAWRENCE & HAUG LLP, 745 Fifth Avenue, New York, NY, 10151, US

(21) Appl. No.: 09/854,771

(22) Filed: May 14, 2001

(30) Foreign Application Priority Data
May 15, 2000 (JP) 2000-141188

(51) Int. Cl. G06F 15/173; G06F 15/16

(52) U.S. Cl. 709/233; 709/226

(57) ABSTRACT

There is provided an information processing device, method thereof and recording medium for evenly allotting band to both a band-guaranteed class and a non-guaranteed class. When packets are transferred from a node 1-1 to a node 1-4, a packet scheduling algorithm performs weighting of the band-guaranteed class and non-guaranteed class according to the following formula, and the calculated band is allotted to the band-guaranteed class and the non-guaranteed class. In the following formula where:

weight=(b_{CX}+B_{excess}+/n)/Bₐₗₗ

b_{CX} is the band allotted to class C_{X}, B_{excess} is any of the surplus band not allotted to any class, and Bₐₗₗ is the total available band of the entire class possessing borrowable attributes.

### BACKGROUND OF THE INVENTION

1. Field of the Invention

The present invention relates to an information processing device, method thereof, and a recording medium, and more particularly to an information processing device preferable to utilize a packet scheduling algorithm, method thereof, and a recording medium.

2. Description of the Related Art

In order for network resource scheduling to effectively utilize network resources when exchanging data between devices mutually connected over a network, the main method for achieving stable communication is to reserve a band matching the maximum transfer rate used by the application. However, when the maximum transmission rate of the application is scheduled in this way, and the scheduled application is always sending data at the maximum transmission rate, the band utilization efficiency certainly improves, but in other cases the problem occurs that band utilization efficiency deteriorates. Another problem is that the resource scheduling could not adequately cope with applications whose maximum transfer rate was not known.

A more flexible resource scheduling method for network resources is the formula called the minimum band guarantee means. The minimum band guarantee means is defined as a means for rendering the following functions for a designated flow group.

(1) Function to allot the guaranteed band. Guarantees transmission when the transmission rate of the flow group is within the guaranteed band.

(2) Function to utilize more than the guaranteed band when a surplus is available on the band of the communication path (network).

A minimum band guarantee means of this kind can improve performance on flows whose maximum transmission rate cannot be specified such TCP (Transmission Control Protocol) or hierarchical encoded flows, etc. The network provider can also provide services such as allotting band that give priority to specially designated sites.

A method for guaranteeing a minimum band using class-based queuing is described next. Class-based queuing is a formula for achieving joint use of resources and was proposed by Dr. S. Floyd of the ACIRI.

In class-based queuing, the flow group is identified based on the class principle. Classes have a tree diagram structure and band can be allotted to each class. When a class utilizes the allotted band space, that class status is then recorded as “satisfied”. When the band utilized by a class is less than the allotted band or when there is a continuous backlog of packets for transmission, then that class status is recorded as “unsatisfied”, and priority rights to the next packet scheduling are granted.

A class also possesses a “Borrowable” attribute. When the total band allotted to a lower class group does not match the band allotted to an upper class group, the “Borrowable” attribute indicates possession of rights to utilize surplus band not allotted to any class. When there are a plurality of classes within the same layer, possessing the borrowable attribute, the surplus band is distributed by means of the packet scheduling algorithm to all classes having the borrowable attribute.

The above packet scheduling algorithm is described next. Two packet scheduling algorithms are used in class-based queuing. These scheduling algorithms are called round-robin scheduling and weighted round-robin scheduling. There are different amounts of surplus band available to a class possessing the borrowable attribute. Round-robin scheduling and weighted round-robin scheduling are therefore explained next in this context. Round-robin scheduling is described first.

In round-robin scheduling, the packet is scheduled based on the following algorithms.

(1) Scheduling is evenly distributed as long as the class is not an “unsatisfied” class.

(2) Scheduling is implemented with the “unsatisfied” receiving priority over the “satisfied” class.

(3) Shifts to processing a lower class.

Scheduling implemented by these algorithms is shown below expressed with a pseudo code.

while (neighbor_class exist) {

if (there is “unsatisfied”) {

if (this class is “unsatisfied”)

schedule this class

} else {

schedule this class

}
process next neighbor_class
}

According to the round robin scheduling algorithm, when the band allotted to class C_{X} is expressed as b_{CX}, the total utilizable band of an entire class possessing the borrowable attribute is Bₐₗₗ, the total surplus band not allotted to any class is B_{excess}, and the total number of classes possessing the borrowable attribute is set as n, then the maximum band C_{X} of class B_{CX} is expressed by the following formula (1).

B_{CX}=b_{CX}(if b_{CX}>Bₐₗₗ/n)

B_{CX}=(B_{excess}−Bₗᵢₘᵢₜ)/(n−nₗᵢₘᵢₜ)(otherwise) (1)

In formula (1), Bₗᵢₘᵢₜ expresses the total sum of the band allotted to a class possessing the borrowable attribute and satisfying the condition that Bₗᵢₘᵢₜ is Bₐₗₗₒₜ>(Bₐₗₗ/n). The nₗᵢₘᵢₜ is the total sum of classes possessing the borrowable attribute and satisfying the condition that b_{CX}>(Bₐₗₗ/n)

Next, another packet scheduling algorithm called the weighted round-robin scheduling algorithm is described. In weighted round-robin scheduling, the packet is scheduled based on the following algorithms.

(1) The weight is calculated from the percentage of band allotted to each class, and is added each round.

(2) Scheduling is performed from a class whose weight has exceeded the threshold provided this is not an “unsatisfied” class. The weighted portion of the scheduled packet is subtracted from the weight.

(3) An “unsatisfied” class receives higher priority scheduling than a “satisfied” class.

(4) Shifts to processing a lower class.

The value for the weight given to class C_{X} is calculated by the following formula (2) utilizing the band b_{CX} allotted to each class C_{X}, and Bₐₗₗ as the total utilizable band of an entire class possessing the borrowable attribute.

weight=b_{CX}/Bₐₗₗ (2)

Scheduling by these algorithms is shown below expressed with a pseudo code.

While (there is “neighbor_class”) {

If (this class is “unsatisfied”)

schedule this class

Process next neighbor_class

}

while (neighbour_class exist) {

wieght += calculate_weight:
if (weight >= packet_send threshold) {

schedule this class

weight −= scheduled packet weight

}
process next neighbor_class

}

The maximum utilizable band B_{CX} for class C_{X} according to this algorithm is expressed by the following formula (3).

B_{CX}=b_{CX}+B_{excess}×b_{CX}/(Bₐₗₗ−B_{excess}) (3)

Class-based queuing is ideal for a minimum band guarantee means. When borrowable attributes are set in each class, the surplus margin not utilized as part of the minimum guaranteed band can also be distributed to each class along with the pre-allotted band.

In many cases, a non-guaranteed band is set as a “non-guaranteed class” in systems utilizing a minimum band guarantee means. In this kind of system, when a surplus band is present, the distribution of that band is allowable even though the band is not guaranteed,. Utilization of band in such kind of non-guaranteed classes is valid when the Internet service provider provides a minimum guaranteed band.

However, in systems suitable for class-based queuing algorithms such as described above, when classes with a guaranteed band and non-guaranteed classes without a non-guaranteed band are both present, problems are likely to occur in the distribution of surplus band. Problems with round-robin scheduling and with weighted round-robin scheduling are respectively described next.

When a packet is scheduled by round-robin scheduling, the maximum band utilizable by each class is calculated by formula (4). Assuming here, a class Cₐ having guaranteed band at a rate of a%, and a class C₀ (non-guaranteed class) having band guaranteed at a rate of 0%, the maximum band B_{Ca} that can be utilized by class Cₐ is expressed by formula (4).

B_{Ca}=a×Bₐₗₗ(if a>0.5)

B_{Ca}=a×Bₐₗₗ/2(otherwise) (4)

The maximum utilizable band B_{C0} of class C₀ is expressed by the following formula (4).

B_{C0}=Bₐₗₗ/2 (5)

When scheduling packets by the round-robin scheduling of formulas (4) and (5), it can be seen that the maximum band B_{Ca} of class Ca matches the maximum band B_{C0} of the non-guaranteed class C₀, when the band allotted to a guaranteed class does not exceed 50%. Therefore, when the Internet service provider provides a minimum guaranteed band as a service to the customer, the user wanting the guaranteed band may then expect to receive high quality service but when the guaranteed band is not very large during round-robin scheduling, the utilizable band is only the same as the non-guaranteed class. Consequently, the advantage of receiving guaranteed band declines.

The case of weighted round-robin scheduling is described next. The maximum utilizable band for each class when scheduling packets by weighted round-robin scheduling can be calculated by means of the previous formula (3). Assuming here only two classes being present, constituted by one class Cₐ having band guaranteed at a rate of a%, and a class C₀ (non-guaranteed class) having band guaranteed at a rate of 0%, the maximum band B_{Ca} that can be utilized by class Cₐ is expressed by the following formula (6).

B_{Ca}=a×Bₐₗₗ+B_{excess}×1.0=Bₐₗₗ (6)

The maximum usable band B_{C0} of class C₀ is expressed in the same way by the following formula (7).

B_{C0}=0×Bₐₗₗ+B_{excess}×0=0 (7)

When scheduling packets by weighted round-robin scheduling of formula (6) and formula (7), the band guaranteed class Cₐ can utilize all band but the band utilizable by the non-guaranteed class C₀ is zero (0). The reason is that when packets are scheduled by weighted round-robin scheduling, the advantage of receiving a guaranteed band diminishes greatly. Restated, the user receiving a guaranteed band (service) can expect high quality service but all other users will only obtain poor and inconvenient service, creating the problem of a large difference in service among users.

Therefore, when providing the two packet scheduling algorithms with a class-based queuing device in this way, the problem of an uneven (or unfair) distribution of minimum guaranteed band will occur during joint band used by guaranteed classes and non-guaranteed classes, regardless of the type of algorithm used.

### SUMMARY OF THE INVENTION

In view of the above stated problems with the related art, it is an object of the present invention to allot band by calculating the weight according to formula (8) so that an uneven distribution of band does not occur between the guaranteed classes and non-guaranteed classes.

An information processing device according to one aspect of the present invention is characterized in that when the band allotted to class C_{X} is expressed as b_{CX}, the total surplus band not allotted to any class is B_{excess}, the total utilizable band of an entire class possessing the borrowable attribute is Bₐₗₗ, and the total number of classes possessing the borrowable attribute is set as n, then weighting is performed according to the value calculated by, weight=(b_{CX}+B_{excess}/n)/Bₐₗₗ, and the band of class C_{X} is determined and scheduled.

An information processing method according to another aspect of the present invention is characterized in that when the band allotted to class C_{X} is expressed as b_{CX}, the total surplus band not allotted to any class is B_{excess}, the total utilizable band of an entire class possessing the borrowable attribute is Bₐₗₗ, and the total number of classes possessing the borrowable attribute is set as n, then weighting is performed according to the value calculated by, weight=(b_{CX}+B_{excess}/n)/Bₐₗₗ, and the band of class C_{X} is determined and scheduled.

A program for a recording medium according to still another aspect of the present invention is characterized in that when the band allotted to class C_{X} is expressed as b_{CX}, the total surplus band not allotted to any class is B_{excess}, the total utilizable band of an entire class possessing the borrowable attribute is Bₐₗₗ, and the total number of classes possessing the borrowable attribute is set as n, then weighting is performed according to the value calculated by, weight=(b_{CX}+B_{excess}/n)/Bₐₗₗ, and the band of class C_{X} is determined and scheduled.

According to the present invention, an information processing device, an information processing method and a recording medium are characterized in that when the band allotted to class C_{X} is expressed as b_{CX}, the total surplus band not allotted to any class is B_{excess}, the total utilizable band of an entire class possessing the borrowable attribute is Bₐₗₗ, and the total number of classes possessing the borrowable attribute is set as n, then weighting is performed according to the value calculated by, weight=(b_{CX}+B_{excess}/n)/Bₐₗₗ, and the band of class C_{X} is determined and scheduled.

Therefore in the invention as described above with an information processing device, an information processing method and a recording medium, when the band allotted to class C_{X} is expressed as b_{CX}, the total surplus band not allotted to any class is B_{excess}, the total utilizable band of an entire class possessing the borrowable attribute is Bₐₗₗ, and the total number of classes possessing the borrowable attribute is set as n, and weighting is then performed according to the value calculated by, weight=(b_{CX}+B_{excess}/n)/Bₐₗₗ, and the band of class C_{X} then determined and scheduled so that the band can be evenly distributed among a plurality of classes.

### BRIEF DESCRIPTION OF THE DRAWINGS

FIG. 1 is a drawing showing the structure of the network embodiment of the present invention.

FIG. 2 is a drawing showing the structure of node 1 in FIG. 1.

FIG. 3 is a graph showing results of a simulation of band utilization when using round-robin scheduling of the related art.

FIG. 4 is a graph showing results of a simulation of band utilization when using weighted round-robin scheduling of the related art.

FIG. 5 is a graph showing results of a simulation of band utilization when using the packet scheduling algorithm of the present invention.

### DETAILED DESCRIPTION OF THE PREFERRED EMBODIMENTS

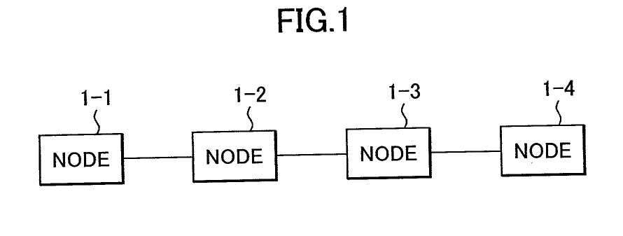

The preferred embodiments of the present invention are next described while referring to the accompanying drawings. A drawing illustrating the structure of the embodiment for the network of the present invention is shown in FIG. 1. The nodes 1-1 through 1-4 are for example connected over a network such as the Internet for the mutual exchange of data. The nodes 1-1 through 1-4 (Hereafter, simply listed as node 1 when separately identifying the nodes 1-1 through 1-4 is not required.) here are personal computers, etc.

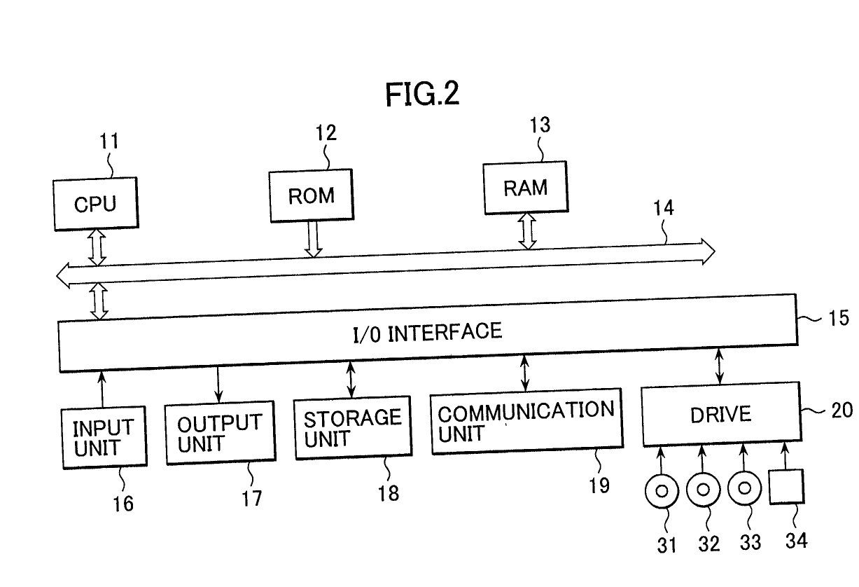

FIG. 2 is a drawing showing the structure of one embodiment of the node 1 in FIG. 1. A CPU11 of the node 1 runs all the processing according to the program stored in a ROM (Read Only Memory) 12. Data and programs required for the CPU11 to implement the various processing are appropriately stored in the RAM (random access memory) 13. An input unit 16 is connected to the I/O interface (I/F) 15 and signals input from the I/O interface 15 are output to the CPU11. A storage unit 18 comprised from the hard disk is also connected to the I/O interface 15, and data and programs can be stored and reproduced in the I/O interface 15. A communications unit 19, and a drive 20 for loading and writing data from recording mediums such as a magnetic disk 31, an optical disk 32, a magneto-optical disk 33 and a semiconductor memory 34; are also connected to the I/O interface 15. These internal components are mutually connected via an internal bus 14.

The communications unit 19 performs packet scheduling based on the following algorithms when sending packets to another node.

(1) Guaranteeing use allotted band for the band guaranteed class.

(2) Evenly distributing surplus band not allotted to any class, among band guaranteed classes and non-guaranteed classes.

These type of algorithms are implemented based on weighted round-robin scheduling. However, instead of formula (2), the calculation for performing the weighting is based on the following formula (8).

weight=(b_{CX}+B_{excess}/n)/Bₐₗₗ (8)

In formula (8), b_{CX} is the band allotted to class C_{X}, the surplus band not allotted to any class is B_{excess}, and Bₐₗₗ is the total utilizable band of an entire class possessing the borrowable attribute.

When scheduling packets by calculations using the weighting of formula (8), the maximum band B_{CX} of class C_{X} capable of being utilized is expressed as shown in formula (9).

B_{CX}=b_{CX}+(B_{excess}/n) (9)

Further, in the weighting calculated by formula (8), when calculating the maximum band with an algorithm such as in formula (9), a maximum band B_{Ca} that can be utilized by a class Cₐ having band guaranteed at a rate of a%, and a maximum band B_{C0} that can be utilized by class C₀ having band guaranteed at a rate of 0%, are expressed respectively by the following formulas (10) and (11).

B_{Ca}=a×Bₐₗₗ+B_{excess}/2 (10)

B_{C0}=0×Bₐₗₗ+B_{excess}/2=B_{excess}/2 (11)

The size of the band allotted to the class Cₐ becomes larger according to the differential between the maximum band B_{Ca} and the maximum band B_{C0} as can be seen from the formulas (10) and (11). By utilizing algorithms in this way for packet scheduling, the band guaranteed class can receive the benefits of a guaranteed band in contrast to the non-guaranteed (band) class. Because the non-guaranteed class can be allotted surplus band, both the band guaranteed class and non-guaranteed class receive an even distribution of band.

Results from a simulation of the above algorithms are shown next to demonstrate the effectiveness of these algorithms. The simulator used was an ns simulator developed by the VINT project. The ns simulator is disclosed in the Floyd. S “Simulator Test” Technical Report, July, 1995. The network for carrying out the simulation is configured as shown in FIG. 1.

The node 1-1 and node 1-2 as well as the node 1-3 and node 1-4 are respectively communication paths for exchanging data at 100 Mbps (megabytes per second). Node 1-1 and node 1-3 are communication paths for exchanging data at 10 Mbps. The network propagation delay is set at two milliseconds. Node 1-2 and node 1-3 and the area between are a bottleneck link.

The flow from node 1-3 towards node 1-4 is set for class-based queuing. The class-based queuing is set for three classes comprised of a class C, with a 10 percent guaranteed band, two non-guaranteed classes C₂ and C₃ not having a guaranteed band.

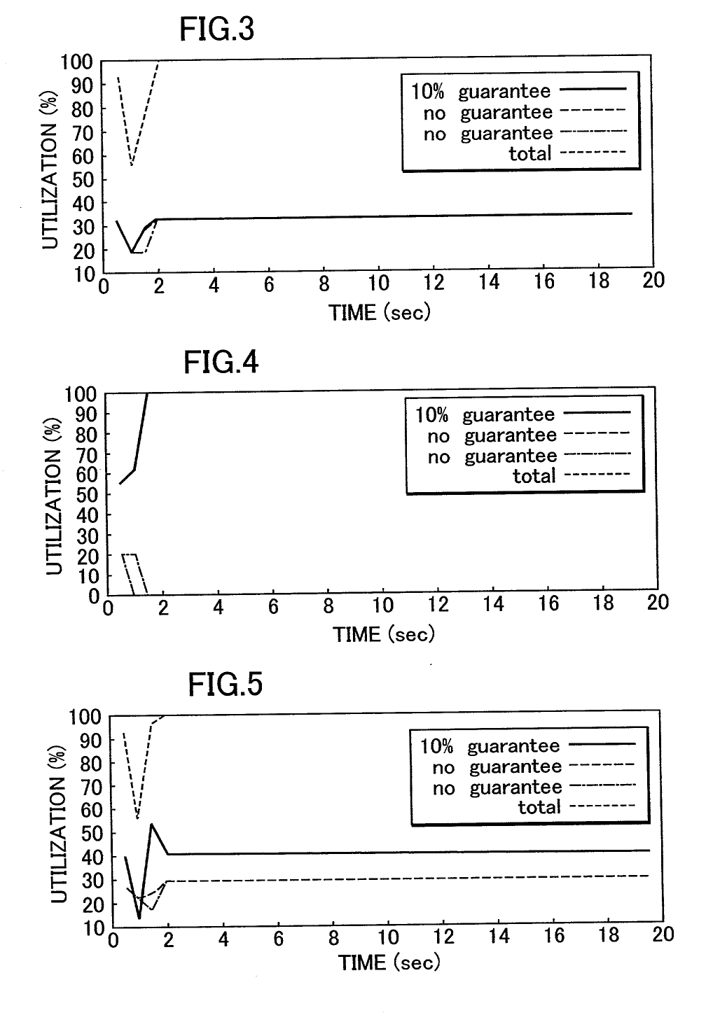

An analysis of band utilization efficiency between node 1-2 and node 1-4 when using these packet scheduling algorithms is shown in FIG. 3, for a network with the above configuration, when a TCP connection is linked to each class and data is sent from node 1-1 towards node 1-4.

FIG. 3 shows analysis results for round-robin scheduling of the related art. The unstable band utilization rate in the interval up to two seconds from the start of transmission is due to a slow-start algorithm during start-up of the TCP connection. This state is also the same for the following analysis results.

In the analysis results from round-robin scheduling of the related art shown in FIG. 3, it can be seen that the band of class C₁ with a guaranteed band and the two non-guaranteed classes C₂ and C₃ not having a guaranteed band are all approximately 33 percent. This state is due to the maximum band when using round-robin scheduling as shown in the above formula (4) and formula (5); and as can be determined from these formulas, when the guaranteed band of class C₁ does not exceed 50 percent, then the maximum band of guaranteed band class C₁, and the maximum band of non-guaranteed classes C₂ and C₃ consequently match each other. The simulation results in FIG. 3 also allow confirming that band is uniformly allocated to the three classes by means of in packet scheduling using round-robin scheduling of the related art.

FIG. 4 shows analysis results of weighted round-robin scheduling of the related art. A look at the analysis results from FIG. 4 confirms that after the two seconds required to establish the TCP connection have elapsed, the guaranteed band class C₁ occupies all (100 percent) of the band. The maximum band when weighted round-robin scheduling is utilized, can be determined as indicated in the formulas (6) and (7). As the formula show, the guaranteed band class C₁ can utilize all the band and the band utilized by the non-guaranteed classes C₂ and C₃ is zero, as can also be confirmed from the simulation results.

Simulation results for the packet scheduling algorithm of the present invention are shown in FIG. 5. After the TCP connection is stably established, it can be seen in FIG. 5 that the band utilization of the guaranteed band class C₁ is 40 percent, and the band utilization of the non-guaranteed classes C₂ and C₃ is respectively 30 percent. In other words, compared to the non-guaranteed classes C₂ and C₃, the guaranteed band class C₁ can be allotted more band equivalent to the guaranteed portion.

As explained above, in the round-robin scheduling of the related art, a uniform amount of band was distributed to the guaranteed band class and non-guaranteed classes. However, the packet scheduling algorithm of the present invention allots a greater amount of band (equivalent to the guaranteed band portion) to the guaranteed band class than to the non-guaranteed class. Further, the non-guaranteed band class not allotted band in the weighted round-robin scheduling of the related art, is however also allotted band in the present invention, by using the packet scheduling algorithm of this invention.

Therefore, it can be seen that the packet scheduling algorithm of the present invention functions efficiently in systems providing a minimum guaranteed band.

Although the above processing was implemented with hardware, the processing may also be implemented with software. When implementing the processing with software, the program comprising that software is embedded in a dedicated computer or each program is separately installed, and so a recording medium such as a general-purpose personal computer is installed with programs capable of running the respective functions.

The recording medium as shown in FIG. 2, is for distributing programs to the user in a separate unit from the computer and is comprised not only of a magnetic disk 31 (including the floppy disk), an optical disk 32 including CD-ROM (compact Disk-Read Only Memory), a DVD (Digital Versatile Disk), a magneto-optical disk 33 including MD (Mini-Disk), or a packaged media such as a semiconductor memory 34, but can also provided to the user already incorporated in a computer such as by a ROM 12 stored with programs or a storage unit 18 on a hard disk.

The term, “system” as referred to in these specifications, indicates the overall device comprised of a plurality of devices.

What is claimed is:

1. An information processing device for scheduling band when transmitting data to other devices over a network, wherein:
when said band allotted to class C_{X} is expressed as b_{CX}, the total surplus band not allotted to any class is B_{excess}, the total utilizable band of an entire class possessing the borrowable attribute is Bₐₗₗ, and the total number of classes possessing the borrowable attribute is set as n, then weighting is performed according to the value calculated by:
weight=(b_{CX}+B_{excess}/n)/Bₐₗₗ,
and said band of class C_{X} is determined and scheduled.

2. An information processing method for an information processing device for scheduling band when transmitting data to other devices over a network, wherein:
when said band allotted to class C_{X} is expressed as b_{CX}, the total surplus band not allotted to any class is B_{excess}, the total utilizable band of an entire class possessing the borrowable attribute is Bₐₗₗ, and the total number of classes possessing the borrowable attribute is set as n, then weighting is performed according to the value calculated by:
weight=(b_{CX}+B_{excess}/n)/Bₐₗₗ,
and said band of class C_{X} is determined and scheduled.

3. A recording medium recorded with a computer-readable program comprising such steps that in an information processing devide for scheduling band when transmitting data to other devices over a network, wherein:
when said band allotted to class C_{X} is expressed as b_{CX}, the total surplus band not allotted to any class is B_{excess}, the total utilizable band of an entire class possessing the borrowable attribute is Bₐₗₗ, and the total number of classes processing the borrowable attribute is set as n, then weighting is performed according to the value calculated by:
weight=(b_{CX}+B_{excess}/n)/Bₐₗₗ,
and said band of class C_{X} is determined and scheduled.
